(19) United States
(12) Patent Application Publication
(10) Pub. No.: US 2005/0082373 A1
(43) Pub. Date: Apr. 21, 2005

(54) Intergrated circuit architecture for smart card and related storage allocating method

(76) Inventors: Fabrice Walter, Marin (CH); Raja Yazigi, St-Blaise (CH)

Correspondence Address: GRIFFIN & SZIPL, PC, SUITE PH-1, 2300 NINTH STREET, SOUTH, ARLINGTON, VA, 22204, US

(21) Appl. No.: 10/495,985

(22) PCT Filed: Nov. 15, 2002
(86) PCT No.: PCT/EP02/10486

(30) Foreign Application Priority Data
Nov. 19, 2001 (EP) 01204405.3

(51) Int. Cl. G06K 19/06

(52) U.S. Cl. 235/492

(57) ABSTRACT

The invention concerns an integrated circuit, particularly for a smart card, including a central unit (1), a non-volatile memory (9) capable of containing the machine code and data, and a memory control unit (8). The integrated circuit is characterized in that the memory control unit includes programmable allocation means (10) for allocating first (9a) and second (9b) spaces of the non volatile memory defined for containing, respectively, the machine code and the data.

The present invention concerns an integrated circuit architecture particularly for smart cards and an associated memory allocation method.

The integrated circuit according to the invention includes, in particular, a central unit, a non-volatile memory capable of containing the machine code and data and a memory control unit. The machine code corresponds to the instructions from the central unit and the data corresponds to other information, like for example, constants or variables.

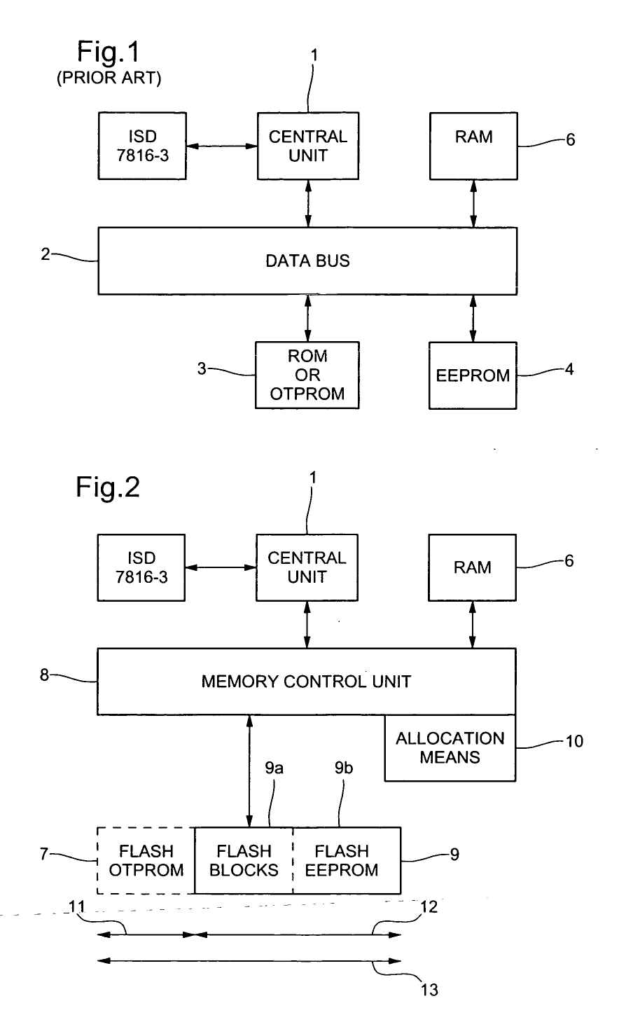

In the smart card field, a conventional integrated circuit is shown in FIG. 1. This circuit includes a central unit 1 connected by a data bus 2 to the various memories present on the circuit.

The circuit contains, in particular, a read-only memory (ROM) for containing the instructions for the central unit, i.e. the machine code, and a non-volatile memory 4 of the electrically erasable programmable read only memory (EEPROM) type for containing data.

This circuit is capable of also including other elements like for example a random access memory (RAM) 6. Using a non-volatile memory of the one time programmable read only memory (OTPROM) type is also known for storing the card operating system, this OTPROM memory being able to replace the ROM.

An integrated circuit architecture as described hereinbefore has, however, several drawbacks. Applications within the smart card field have become very numerous and the memory needs that they require are very different from one client to another.

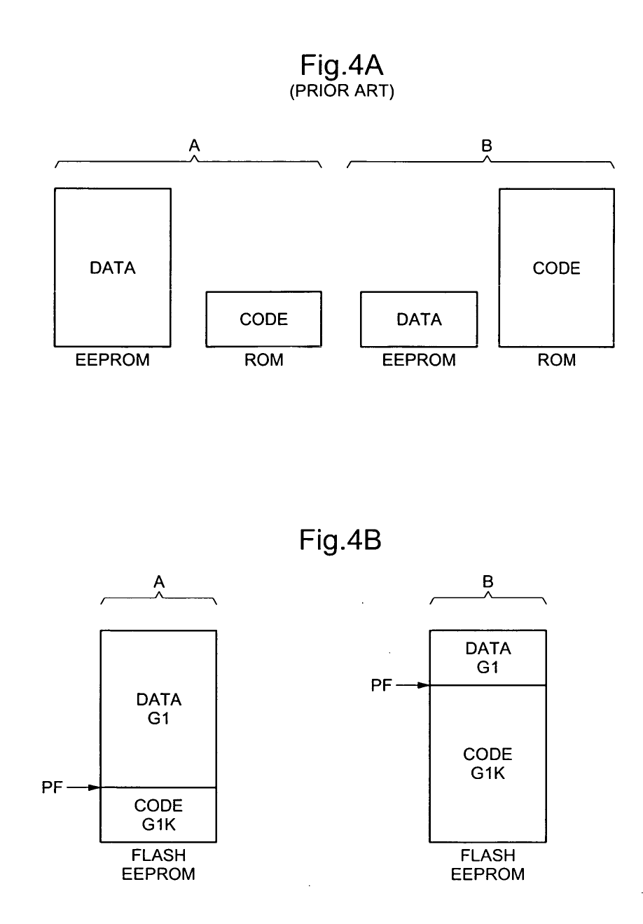

FIG. 4A is an example of the memory needs necessary for two different groups of applications A and B.

The first group of applications A requires the allocation of an EEPROM memory space for the data, for example 128 Kbytes, and the allocation of a ROM memory space for the machine code, for example 64 Kbytes.

The second group of applications B requires the allocation of a different EEPROM memory space for the data, for example 64 Kbytes, and the allocation of a different ROM memory space for the machine code, for example 128 Kbytes.

According to this example, with a circuit architecture like that shown in FIG. 1, two different circuits have to be available to meet the memory needs of the two groups of applications A and B.

More generally, each client has different groups of applications, which means that a wide range of circuits must be provided in order to satisfy memory needs insofar as possible for each group of applications for each client.

For evident reasons of research and development costs, such a solution is not optimal and is not commercially feasible in a field as competitive as that of smart cards.

One idea could consist in providing sufficiently large ROM and EEPROM memories to be able to contain respectively the machine code and the data, whatever the memory needs of the client. This solution is not commercially feasible because of the space required by these memories on the circuit and is unsatisfactory because of the low average memory occupation rate depending on the various clients.

The circuit architecture according to the invention is characterized in that it enables the circuit manufacturing costs to be significantly reduced, while reducing the place occupied by the memory space on the circuit, as well as improving the average occupation rate of said space.

The integrated circuit according to the invention, in addition to the features defined in the preamble is characterized in that the memory control unit includes programmable allocation means for allocating at least a first and a second defined non-volatile memory space for containing respectively the machine code and the data.

Preferably, a FLASH EEPROM memory is used. This type of memory is advantageous in that it does not take up much place on the circuit, in that it provides a wide memory granularity range for the memory spaces able to be allocated, and also in that its cost is reduced.

The invention also concerns the method for allocating this non-volatile memory.

The invention will be explained in detail hereinafter for an embodiment given solely by way of example, this embodiment being illustrated by the annexed drawings, in which:

FIG. 1, already described, shows the conventional structure of an integrated circuit on a smart card;

FIG. 2 shows an integrated circuit structure according to the invention;

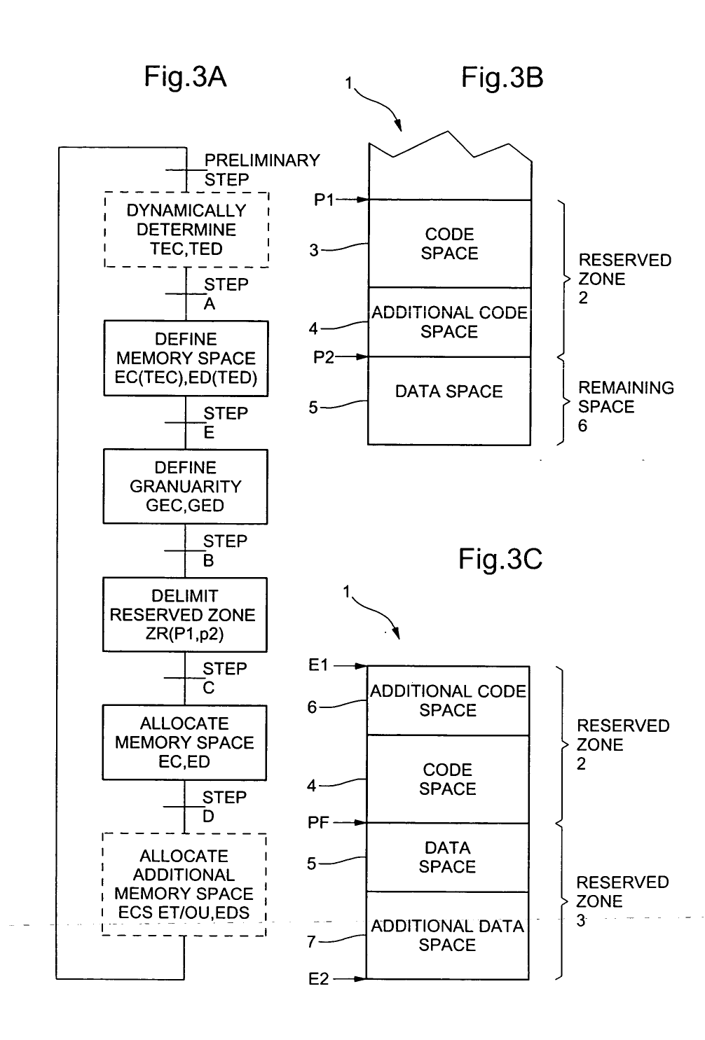

FIG. 3A shows the memory allocation method of the invention in accordance with a first allocation mode;

FIG. 3B shows the configuration of the memory in accordance with this first allocation mode;

FIG. 3C shows the configuration of the memory in accordance with a second allocation mode;

FIG. 4A, already described, shows an example memory allocation in accordance with the prior art for various memory needs;

FIG. 4B shows the memory allocation according to the invention of the example shown in FIG. 4A.

FIG. 2 represents an integrated circuit structure for smartcards according to the invention.

The integrated circuit according to the invention includes, in particular, a central unit 1 connected to a memory control unit 8 for controlling the various memories. The circuit is capable of including a RAM memory 6 and a non-volatile memory 7 of the OTPROM type for containing the operating system.

In addition to the aforementioned elements, the circuit also includes a non-volatile memory 9 capable of containing the machine code and data. This non-volatile memory 9 is preferably a FLASH EEPROM type memory, i.e. an EEPROM memory with greatly reduced programming times. The double arrows 11, 12 and 13 represent respectively the minimum code space, the maximum data space and the maximum code space. Code space 9a, outside space 7 that may be reserved for the operating system, and data space 9a are thus of variable size within the limits defined herein before.

This type of FLASH memory enables a memory granularity to be defined from one byte to several kilo bytes. It is important to note that the memory is broken down beforehand into a certain number of blocks of a predefined size, for example a byte, defining the finest granularity or nominal granularity.

It is possible to define, for a determined memory zone, a multiple granularity from this nominal granularity, this memory zone then being broken down into blocks of a size corresponding to the multiple granularity, for example one kilo byte. Such multiple granularity can be obtained particularly by connecting blocks of a size corresponding to the nominal granularity, by means of the memory control block.

Erasure operations in this zone are then carried out across an entire block of a size corresponding to the multiple granularity. Conversely, it is possible to carry out write operations on a block of a size corresponding to the nominal granularity.

Memory control unit 8 includes programmable allocation means 10 for FLASH memory 9. These programmable allocation means can be, in particular, means for reconfiguring the memory mapping by modifying the mapping between the machine code and the data.

According to a preferred embodiment of the circuit, programmable allocation means 10 are formed by allocation software.

“Allocation software” means a programme enabling instructions to be sent to central unit 1, in accordance with the information with which it is provided, for allocating the various memory spaces. This programme can in particular check whether the overall memory space available is sufficient, and in such case, can define, for example by means of pointers, the start and end of the memory space reserved for the code, and that reserved for the data.

Depending upon the memory space necessary to contain the code and the data, first and second memory spaces each having the necessary size are defined, and allocation software 10 is programmed accordingly. Thus, memory 9 includes a code space and a data space corresponding to the needs of the client's applications. This solution is advantageous in that the client himself can use it.

According to a variant of this preferred embodiment, the software can be dynamically configured in response to a dynamic definition of the memory spaces, code and data to be allocated. During installation of the applications of a given client, the allocation software evaluates the necessary memory spaces for containing the code and the data, and allocates the corresponding memory spaces in accordance with the defined allocation mode.

As was already mentioned hereinbefore, the FLASH memory is defined with a nominal granularity. The allocation software can be programmed so as to define, for a memory space to be allocated, a multiple granularity from the nominal granularity, so as to accelerate particularly the erasure or programming operations.

For example, the data space is allocated with the finest granularity, i.e. the nominal granularity, to enable specific write or erasure operations. And the code space is allocated with a larger granularity, for example a thousand times the nominal granularity, to allow fast write or erasure operations.

The invention also concerns the allocation method for the non-volatile memory, such method depending upon the programming of the programmable allocation means of the control unit.

FIG. 3A shows an allocation method for the non-volatile memory according to a first allocation mode.

Depending upon the clients' needs, at step (a), at least two memory spaces are defined by the programming of the allocation means, for containing respectively machine code and data, called code space EC and data- space ED,- each having a - determined size TEC and TED.

Increasingly, for the sake of secrecy as regards card manufacturers, clients wish to carry out the installation of their applications themselves, without worrying about the memory needs that they require. This is why, preferably, dynamic allocation means are provided. “Dynamic allocation” means the capacity of the software to evaluate, when an application is installed, the code and data memory needs required by the application.

If dynamic allocation means are used, determination of the sizes of code space TEC and data space TED occurs during a preliminary step during which said means dynamically determine the necessary sizes.

Step (b) consists in delimiting a reserved memory zone ZR having a size greater than or equal to the determined size of code space TEC or data space TED. Thus, the overall memory space of the non-volatile memory is cut in two, the reserved zone ZR and the memory space outside this reserved zone. Two memory points P1 and P2 are defined to delimit this reserved zone.

Step (c) consists in allocating code space EC in the reserved memory zone ZR and allocating data space ED in the remaining memory space, or conversely.

It should be noted that the size of the reserved zone ZR can be greater than the size of code space TEC defined in step (a), or of data space TED depending upon the particular case. This leaves the possibility of being able to allocate an additional code space ECS, or data space EDS, in the unallocated reserved zone.

Step (d) consists in allocating this additional code or data space ECS or EDS in the unallocated reserved zone, to extend the memory capacity used for the machine code or the data.

It is also possible to allocate an additional code space and an additional data space ECS and EDS, respectively in the unallocated reserved zone and in the remaining unallocated memory space, or conversely. As for the allocation of the code and data spaces, a dynamic size determination step (preliminary step) and a step for defining additional spaces (step a), not shown in FIG. 3A, could be provided for the allocation of these additional spaces.

This solution is advantageous in that it means that the memory capacity of the code or data space can be extended without having to redefine the whole of the memory allocation. This is particularly advantageous when certain applications are updated, or when a new application is added.

If a FLASH EEPROM memory is used as the memory for containing the machine code and data, an additional step (e) is provided between steps (a) and (b). Since the FLASH memory is defined with a determined nominal granularity, step (e) consists in defining a specific granularity that is a multiple of said nominal granularity, for each allocated memory space EC, ED, ECS and EDS.

If a multiple granularity is defined, the memory control unit sends a code generated by the allocation means to the central unit which controls the connection of blocks of a size corresponding to the nominal granularity so as to form blocks of a size corresponding to the multiple granularity in the memory space to be allocated.

FIG. 3B shows the memory configuration according to this first allocation mode.

In non-volatile memory 1, memory points P1 and P2 delimit a reserved zone 2. This zone 2 contains, in this example, code space 3 and an additional code space 4, data space 5 being outside this reserved zone 2. The additional code space 4 is an extension possibility for code space 3. It is entirely possible to delimit reserved zone 2 so that code space 3 fills all of this zone. It is also possible to envisage not using all of the remaining memory space 6 with data space 5 and to allow the possibility of allocating an additional data space, which is not shown.

It is also possible to allocate the memory by using other allocation modes. An example according to a second mode will be given here. This second allocation mode differs from the first mode as regards steps (b) and (c) and (d), steps (a), (e) and the preliminary steps remaining unchanged.

According to this second mode step (b) consists in delimiting two reserved memory zones ZR1 and ZR2 each having a size greater than or equal to, respectively, the determined sizes of code space TEC and data space TED. These zones are delimited by the definition of a border memory point cutting the non-volatile memory into these two zones ZR1 and ZR2.

Step (c) consists in allocating code space EC and data space ED, respectively, inside first and second reserved zones ZR1 and ZR2, or conversely.

For the case in which the size of the reserved zones is larger than the size of the code and data spaces, step (d) consists in allocating an additional code space and/or an additional data space, respectively, in the unallocated first and second reserved zones or conversely.

FIG. 3C shows the memory configuration in accordance with this second allocation mode.

Non-volatile memory 1 is cut into two reserved zones 2 and 3 by a border point PF. For example, code space 4 is allocated in reserved zone 2 from border point PF and data space 5 is allocated in reserved zone 3 from the same border point PF. It is also possible to allocate the code and data spaces 4 and 5 from the ends E1 and E2 of the memory towards border point PF.

In this example, since the size of reserved zones 2 and 3 is greater than the size of code and data spaces 4 and 5, additional code and data spaces 6 and 7 are allocated, respectively in unallocated spaces 8 and 9 of reserved zones 2 and 3.

FIG. 4B shows the memory allocation according to the invention in comparison to the memory allocation of the example given in FIG. 4A.

Taking again the two groups of applications A and B with the same memory needs, by using, for example, the allocation mode according to the second mode, it is possible to cut the memory into two spaces, one receiving the machine code and the other the data. Depending upon the size determined for the code space and for the data space, border point PF is placed differently.

It is important to note that other allocation modes for the method can form the subject of the present invention, particularly in the arrangement of various memory spaces inside the non-volatile memory, without thereby departing from the scope of the invention.

It is also important to note that the integrated circuit according to the invention is developed with an architecture respecting regulation ISO 7816-3.

1. (canceled)

2. (canceled)

3. (canceled)

4. (canceled)

5. (canceled)

6. (canceled)

7. (canceled)

8. (canceled)

9. (canceled)

10. (canceled)

11. An integrated circuit, particularly for a smart card, including a central unit, a non volatile memory capable of containing machine code and data, and a memory control unit, wherein said memory control unit includes programmable allocation means for allocating at least a defined first and second spaces of said non volatile memory defined for containing, respectively, said machine code and said data.

12. The integrated circuit according to claim 11, wherein said programmable allocation means allow said first and second spaces of said non volatile memory to be allocated dynamically in response to a dynamic definition of said first and second spaces for containing said machine code and said data.

13. The integrated circuit according to claim 11, wherein said non volatile memory can be broken down into a determined number of memory blocks of the same size defining a nominal granularity for said memory.

14. The integrated circuit-according to claim 12, wherein said non volatile memory can be broken down into a determined number of memory blocks of the same size defining a nominal granularity for said memory.

15. The integrated circuit according to claim 13, wherein said programmable means further enable different granularities to be defined, which are multiples of said nominal granularity, according to said first and second memory spaces of said memory.

16. The integrated circuit according to claim 14, wherein said programmable means further enable different granularities to be defined, which are multiples of said nominal granularity, according to said first and second memory spaces of said memory.

17. An allocation method for a non volatile memory of an integrated circuit, particularly for a smart card, including a central unit, a non volatile memory capable of containing machine code and data, and a memory control unit, wherein said memory control unit includes programmable allocation means for allocating at least a defined first and second spaces of said non volatile memory defined for containing, respectively, said machine code and said data, wherein the method includes the steps of:
a. defining first and second memory spaces for containing, respectively, the code and the data, or conversely, each having a determined memory size;
b. delimiting at least one reserved memory zone having a size greater than or equal to the determined memory size of said first memory space; and
c. allocating said first and second memory spaces, respectively inside and outside the reserved memory zone.

18. The allocation method according to claim 17, wherein step (b) further comprises:
defining two memory points delimiting the reserved memory zone having a size greater than or equal to the determined size of said first memory space defined in step (a).

19. The allocation method according to claim 17, wherein step (b) further comprises:
defining a border point cutting the non volatile memory into two delimiting first and second reserved memory zones each having a size greater than or equal to, respectively, the determined sizes of said first and second memory spaces defined in step (a); and
wherein step (c) further comprises:
allocating said first and second memory spaces inside, respectively, said first and second reserved memory zones.

20. The allocation method according to claim 17, further including an additional step of:
d—allocating at least a third additional memory space for containing said machine code or data, in an unallocated zone of said at least one reserved memory zone.

21. The allocation method according to claim 17, said non volatile memory having a determined nominal granularity, and further including the additional step of:
e—defining a specific granularity that is a multiple of said nominal granularity for each allocated memory space.

22. The allocation method according to claim 17, said programmable allocation means enabling a dynamic allocation, and further including a preliminary step of: dynamically determining the memory size necessary to contain said machine code and the data.
